(19) United States
(12) Patent Application Publication
(10) Pub. No.: US 2007/0022172 A1
(43) Pub. Date: Jan. 25, 2007

(54) Controlling presentation of instant messages to a recipient

(76) Inventors: Howard N. Anglin, Austin, TX (US); Wen Hsu, Austin, TX (US); Frank A. Nuzzi, Round Rock, TX (US); Jan Rogoyski, Pflugerville, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/184,351

(22) Filed: Jul. 19, 2005

(51) Int. Cl. G06F 15/16

(52) U.S. Cl. 709/207

(57) ABSTRACT

Methods, systems, and products are provided for controlling presentation of instant messages to a recipient in a data processing system. Embodiments include establishing threshold priority criteria, receiving an instant message, determining whether the instant message meets the threshold priority criteria, and presenting to the recipient the instant message if the instant message meets the threshold priority criteria. Determining whether the instant message meets the threshold priority criteria may be carried out by identifying attributes of the instant message and determining whether the attributes of the instant message meet the threshold priority criteria in dependence upon criteria evaluation rules.

### BACKGROUND OF THE INVENTION

1. Field of the Invention

The field of the invention is data processing, or, more specifically, methods, systems, and products for controlling presentation of instant messages to a recipient.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Instant messaging (‘IM’) is a type communication application useful in the business environment. Instant messaging is an internet protocol-based application providing for direct communication between users at different devices. An IM client at one computer communicates with an IM server to obtain connection information for an IM client at another computer, and establishes a connection with the other IM client. Examples of IM include Microsoft's Windows Messenger™, AOL's Instant Messenger™, and Mirabilis' ICQ™. Instant messaging (‘IM’) has now become a fully accepted part of the daily business working environment, particularly among high-tech businesses. In fact, the importance of IM to business is recognized by the SEC requirement that brokerage firms save and archive all IM messages for auditing purposes.

Conventional instant messaging application often displays received instant messages displayed in windows that take the focus of the display. Such windows do not, however, provide any additional information regarding the instant message. Furthermore, such windows present to recipients all instant messages regardless of the instant messages' importance or relevance to the recipient. As recipients receive more and more instant messages, such presenting the instant messages in this manner is cumbersome and inefficient to the recipient.

### SUMMARY OF THE INVENTION

Methods, systems, and products are provided for controlling presentation of instant messages to a recipient in a data processing system. Embodiments include establishing threshold priority criteria, receiving an instant message, determining whether the instant message meets the threshold priority criteria, and presenting to the recipient the instant message if the instant message meets the threshold priority criteria. Determining whether the instant message meets the threshold priority criteria may be carried out by identifying attributes of the instant message and determining whether the attributes of the instant message meet the threshold priority criteria in dependence upon criteria evaluation rules.

Presenting to the recipient the instant message if the instant message meets the threshold priority criteria may be carried out by selecting one of a plurality of prioritized windows to present the instant message in dependence upon attributes of the instant message and at least one presentation rule and presenting the instant message in the selected window. Presenting to the recipient the instant message if the instant message meets the threshold priority criteria may also be carried out by selecting a position in an instant message box list for an identification of the instant message in dependence upon attributes of the instant message and at least one presentation rule, inserting an identification of the instant message in the instant message box list, and presenting the instant message box list to the recipient. Presenting to the recipient the instant message if the instant message meets the threshold priority criteria may also be carried out by creating instant message metadata describing the instant message and presenting to the recipient the instant message metadata.

Typical embodiments also include forwarding, in an email message, the content of the instant message if the instant message does not meet the threshold priority criteria. Forwarding, in an email message, the content of the instant message if the instant message does not meet the threshold priority criteria may be carried out by copying the content of the instant message, inserting at least a portion of the content of the instant message in an email message, and sending the email message to the recipient.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system useful in controlling presentation of instant messages to a recipient according to embodiments of the present invention.

FIG. 2 sets forth a block diagram of automated computing machinery comprising an exemplary computer useful in controlling presentation of instant messages to a recipient according to embodiments of the present invention.

FIG. 3 sets forth a diagram illustrating exemplary data structures useful in controlling presentation of instant messages to a recipient according to embodiments of the present invention.

FIG. 4 sets forth a flow chart illustrating an exemplary method for controlling presentation of instant messages to a recipient in accordance with the present invention.

FIG. 5 sets forth a flow chart illustrating an exemplary method for determining whether the instant message meets the threshold priority criteria.

FIG. 6 sets forth a flow chart illustrating an exemplary method for presenting to the recipient the instant message if the instant message meets the threshold priority criteria.

FIG. 7 sets forth a flow chart illustrating an exemplary method for presenting to the recipient the instant message if the instant message meets the threshold priority criteria.

FIG. 8 sets forth a flow chart illustrating an exemplary method for presenting to the recipient the instant message if the instant message meets the threshold priority criteria.

FIG. 9 sets forth a flow chart illustrating an exemplary method for forwarding, in an email message, the content of the instant message if the instant message does not meet the threshold priority criteria.

FIG. 10 sets forth a block diagram illustrating three exemplary prioritized windows each of which contain an instant message presented to a recipient in accordance with the present invention.

FIG. 11 sets forth a block diagram illustrating an exemplary instant message box list in accordance with the present invention.

### DETAILED DESCRIPTION OF EXEMPLARY EMBODIMENTS

### Controlling Presentation of Instant Messages to a Recipient

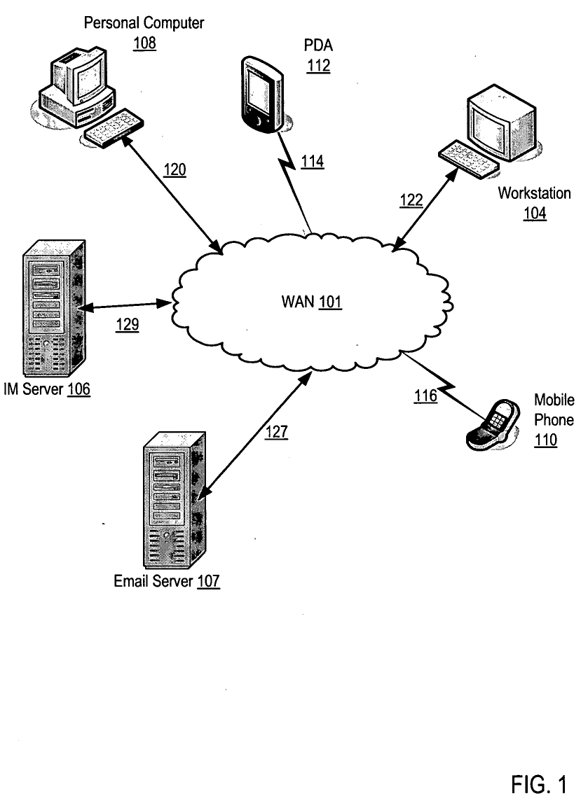

Exemplary methods, systems, and products for controlling presentation of instant messages to a recipient according to embodiments of the present invention are described with reference to the accompanying drawings, beginning with FIG. 1. FIG. 1 sets forth a network diagram illustrating an exemplary system useful in controlling presentation of instant messages to a recipient according to embodiments of the present invention. The term ‘network’ is used in this specification to mean any networked coupling for data communications among two or more computers. Network data communication typically is implemented with specialized computers called routers. Networks typically implement data communications by encapsulating computer data in messages that are then routed from one computer to another. A well known example of a network is an ‘internet,’ an interconnected system of computers that communicate with one another according to the ‘Internet Protocol’ as described in the IETF's RFC 791. Other examples of networks useful with various embodiments of the present invention include intranets, extranets, local area networks (‘LANs’), wide area networks (“WANs”), and other network arrangements as will occur to those of skill in the art.

The system of FIG. 1 includes a data communications network (101). Network (101) provides data communications between computing devices or computers communicatively coupled to the network (101). Each of the client computers (108, 112, 104, 110) communicatively coupled to the network (101) in FIG. 1 has installed upon it computer program instructions for controlling presentation of instant messages to a recipient and is capable of controlling presentation of instant messages to a recipient by establishing threshold priority criteria, receiving an instant message, determining whether the instant message meets the threshold priority criteria, and presenting to the recipient the instant message if the instant message meets the threshold priority criteria.

Computers communicatively coupled to network (101) and useful in controlling presentation of instant messages to a recipient in the system of FIG. 1 include:
workstation (104), a computer coupled to network (101) through wireline connection (122);
personal digital assistant (112), coupled to network (101) through wireless connection (114);
personal computer (108), coupled to network (101) through wireline connection (120);
IM server (106), coupled to network (101) through wireline connection (129);
email server (107), coupled to network (101) through wireline connection (127); and
mobile phone (110), coupled to network (101) through wireless connection (116).

Each of the client computers (104, 112, 108, and 110) in FIG. 1 is improved for controlling presentation of instant messages to a recipient by establishing threshold priority criteria; receiving an instant message; determining whether the instant message meets the threshold priority criteria; and presenting to the recipient the instant message if the instant message meets the threshold priority criteria.

The arrangement of servers and other computers making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

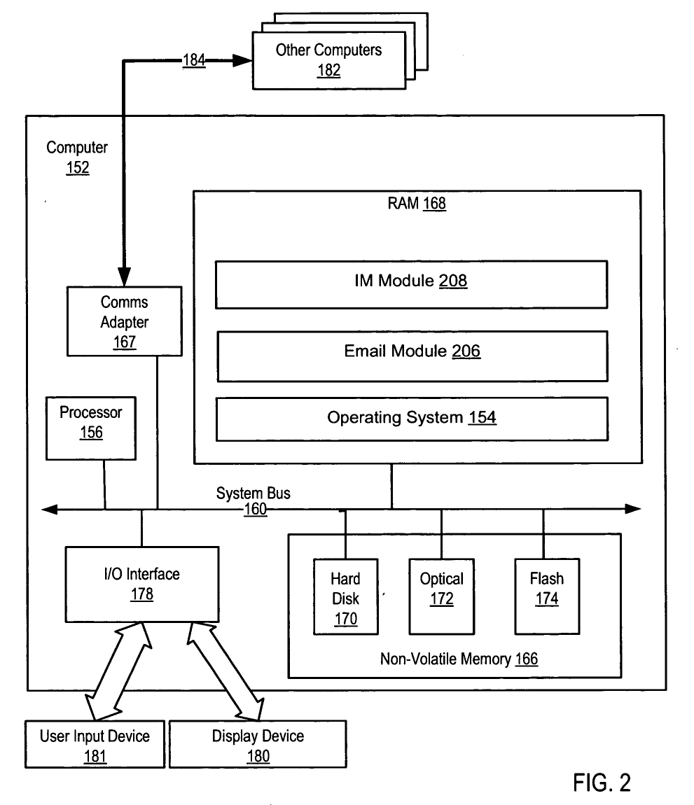

Controlling presentation of instant messages to a recipient in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in controlling presentation of instant messages to a recipient according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is an IM module (208). Instant messaging is an internet protocol-based application providing for direct communication between users at different devices. An IM module at one computer communicates with an IM server to obtain connection information for an IM module at another computer and establishes a connection with the other IM client. Having established a connection, the IM clients communicate directly with one another. The exemplary IM module is improved for controlling presentation of instant messages to a recipient according to embodiments of the present invention. The IM module is capable of receiving an instant message; determining whether the instant message meets the threshold priority criteria; and presenting to the recipient the instant message if the instant message meets the threshold priority criteria.

Also stored in RAM (168) is an email module (206). Email is a system of world-wide electronic communication in which electronic messages and computer files are exchanged between computers that are connected by a network or networks. Typically, an email client at one computer sends a message to an email server. The message is downloaded from the server by the receiving email client at another computer. The email client of FIG. 2 is modified according to embodiments of the present invention to forward forwarding, in an email message, the content of the instant message if the instant message does not meet the threshold priority criteria.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), email module (206), and IM module (208) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

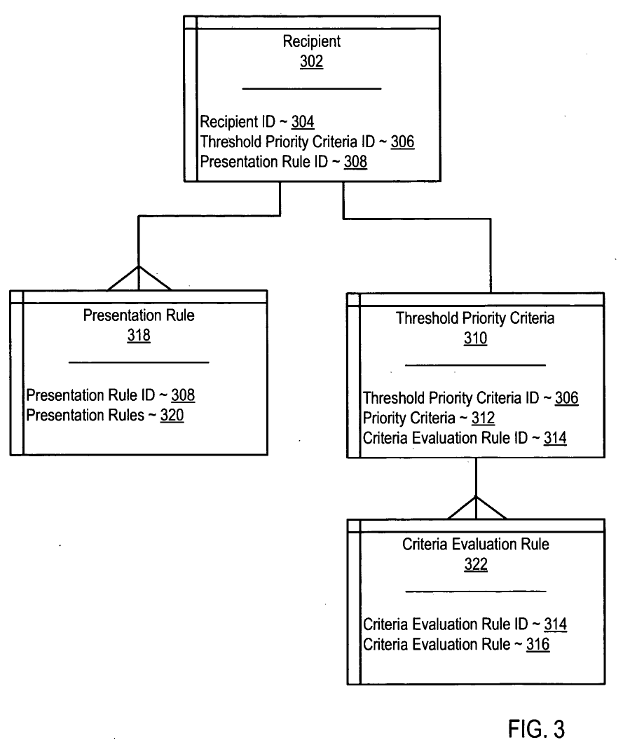

For further explanation, FIG. 3 sets forth a diagram illustrating exemplary data structures useful in controlling presentation of instant messages to a recipient according to embodiments of the present invention. The exemplary data structures of FIG. 3 include a recipient record (302). The recipient record (302) represents a recipient of an IM message for whom controlling presentation of instant messages to a recipient according to embodiments of the present invention is carried out. The exemplary recipient record (302) of FIG. 3 includes a recipient ID (304) that uniquely identifies the recipient. The recipient record (302) includes a threshold priority criteria ID (306) relating the recipient record (302) to a threshold priority criteria record (310). The recipient record (302) includes a presentation rule ID (308) field relating the recipient record (302) to one or more records representing presentation rules.

The exemplary data structures of FIG. 3 includes a threshold priority criteria record (310) that represents threshold priority criteria for a recipient for controlling presentation of instant messages to a recipient according to embodiments of the present invention. Threshold priority criteria are priority criteria are used to determine whether an instant message received by a recipient has sufficient priority to present the instant message to the recipient. If the instant message does not have sufficient priority to be presented to the user, controlling presentation of instant messages to a recipient according to embodiments of the present invention may also include forwarding, in an email message, the content of the instant message. Threshold priority criteria may be established for a recipient by the recipient, by another user for the recipient, such as for example, by a user's employer, or by any other user or entity that will occur to those of skill in the art.

The exemplary threshold priority criteria record (310) of FIG. 3 is related one-to-one with the recipient record (302). The exemplary threshold priority criteria record (310) of FIG. 3 also includes a threshold priority criteria ID (306) uniquely identifying the threshold priority criteria.

The exemplary threshold priority criteria record (310) of FIG. 3 includes a priority criteria field (312) that contains priority criteria for evaluating the priority of the instant message. Priority criteria is one or more factors or conditions surrounding the instant message, or contents of the instant message established by a user for evaluating the priority of received instant messages. Examples of priority criteria include users who send or receive the instant message, the time of receipt of the instant message, one or more keywords included in the instant message, the identity of one or more applications running on the recipients computer when the instant message is received, the arrival rate of a plurality of instant messages, the subject matter of the instant message, and any other factors or conditions surrounding the instant message, or contents of the instant message that will occur to those of skill in the art.

The exemplary threshold priority criteria record (310) of FIG. 3 also includes criteria evaluation rule ID field (314) relating the priority criteria record (310) to one or more criteria evaluation rule records (322). The criteria evaluation rule record (322) of FIG. 3 represents criteria evaluation rules used to determine whether an instant message received by a recipient meets the threshold priority criteria. If the instant message meets the threshold priority criteria the instant message is typically presented to the recipient. If the instant message does not meet the threshold priority criteria the content of the instant message is typically forwarded to the recipient in an email message.

The criteria evaluation rule record (322) of FIG. 3 is related many-to-one to the threshold priority criteria record (310) through the criteria evaluation rule ID (314) field. The criteria evaluation rule record (322) of FIG. 3 includes a criteria evaluation rule ID field (314) uniquely identifying the criteria evaluation rule. The criteria evaluation rule record (322) of FIG. 3 also includes a criteria evaluation rule (316) for determining whether an instant message received by a recipient meets the threshold priority criteria. For further explanation, consider the following exemplary criteria evaluation rule:
If instant message received from Supervisor; AND
If instant message received before 5:00 p.m.; THEN
   instant message meets threshold priority criteria.

The exemplary criteria evaluation rule above determines that the instant message meets the threshold priority criteria based upon two priority criteria; the sender of the instant message being the recipient's supervisor and the time of receipt of the instant message. The exemplary criteria evaluation rule above determines that the instant message is of sufficient priority if instant message received from the recipient's supervisor before 5:00 p.m. If instant message received from the recipient's supervisor before 5:00 p.m., controlling presentation of instant messages to a recipient according to embodiments of the present invention include presenting the instant message to the recipient. If instant message does not meet threshold criteria as defined by this or any other criteria evaluation ruled, controlling presentation of instant messages to a recipient according to embodiments of the present invention typically includes forwarding, in an email message, the content of the instant message.

The exemplary data structures of FIG. 3 also includes a presentation rule record (318) related many-to-one to the recipient record (302) through the presentation rule Id field (308). The exemplary presentation rule record (318) includes a rule governing the presentation of instant messages that are determined to be of sufficient priority to be presented to the recipient. The exemplary presentation rule record (318) includes a presentation rule ID (308) uniquely identifying a presentation rule. The exemplary presentation rule record (318) includes a presentation rule (320) governing the presentation of instant messages that are determined to be of sufficient priority to be presented to the recipient. Instant messages that are determined to be of sufficient priority to be presented to the recipient may be presented by, for example, selecting one of a plurality of prioritized windows to present the instant message and presenting the instant message in the selected window. Presenting the instant message in a selected prioritized window allows the highest priority instant messages to be presented, for example, in the top window and the lowest priority instant messages to be presented in the bottom window.

Instant messages that are determined to be of sufficient priority to be presented to the recipient may be presented by, for example, selecting a position in an instant message box list for an identification of the instant message, inserting an identification of the instant message in the instant message box list, and presenting the instant message box list to the recipient. Presenting the instant message in a position in a message box list allows for a convenient way of presenting the recipient with a instant messages that are of sufficient priority.

For further explanation, consider the following presentation rule:
If instant message meets threshold priority criteria; AND
If instant message received from Supervisor; THEN
   Select top window; AND
   Present in top window.

The exemplary presentation rule above operates to select the top window, or most highly prioritized window, and presents the instant message in the top window if the instant message meets the threshold priority criteria and is sent by the recipient's supervisor. The exemplary presentation rule is an example of the so-called ‘pop-on-top’ presentation of the instant messages.

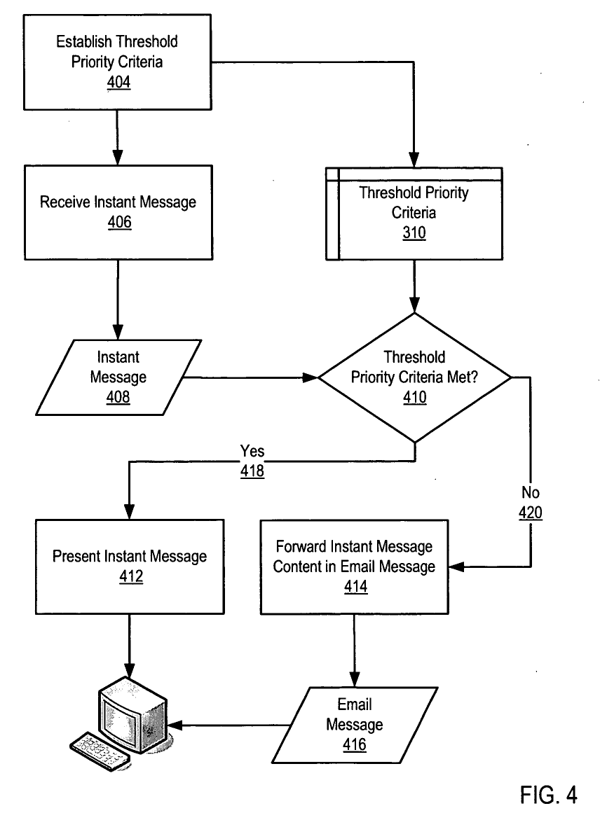

For further explanation, FIG. 4 sets forth a flow chart illustrating an exemplary method for controlling presentation of instant messages to a recipient. The method of FIG. 4 includes establishing (404) threshold priority criteria (310). As described above, threshold priority criteria include one or more factors or conditions surrounding the instant message, or contents of the instant message which operate as a threshold for evaluating the priority of received instant messages. Examples of threshold priority criteria include users who send or receive the instant message, the time of receipt of the instant message, one or more keywords included in the instant message, the identity of one or more applications running on the recipients computer when the instant message is received, the arrival rate of a plurality of instant messages, the subject matter of the instant message, and any other factors or conditions surrounding the instant message, or contents of the instant message that will occur to those of skill in the art.

Establishing (404) threshold priority criteria (310) may be carried out by prompting, through for example a threshold priority criteria creation wizard, an instant message recipient for threshold priority criteria and receiving from the recipient threshold priority criteria. Such threshold priority criteria may then be saved for the recipient and used to determine whether instant messages received after the establishment of the threshold priority criteria meets the established threshold priority criteria. Threshold priority criteria may also be established for a recipient by another user for the recipient, such as for example, by a user's employer, or by any other user or entity that will occur to those of skill in the art.

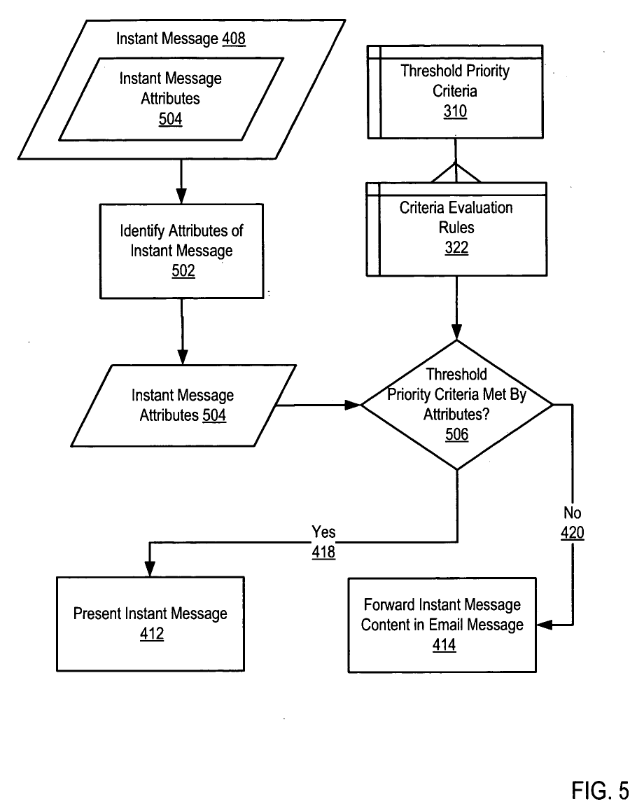

The method of FIG. 4 also includes receiving (406) an instant message (408) and determining (410) whether the instant message (408) meets the threshold priority criteria (310). Determining whether the instant message meets the threshold priority criteria according to the method of FIG. 4 may be carried out by identifying attributes of the instant message and determining whether the attributes of the instant message meet the threshold priority criteria in dependence upon criteria evaluation rules as discussed below with reference to FIG. 5.

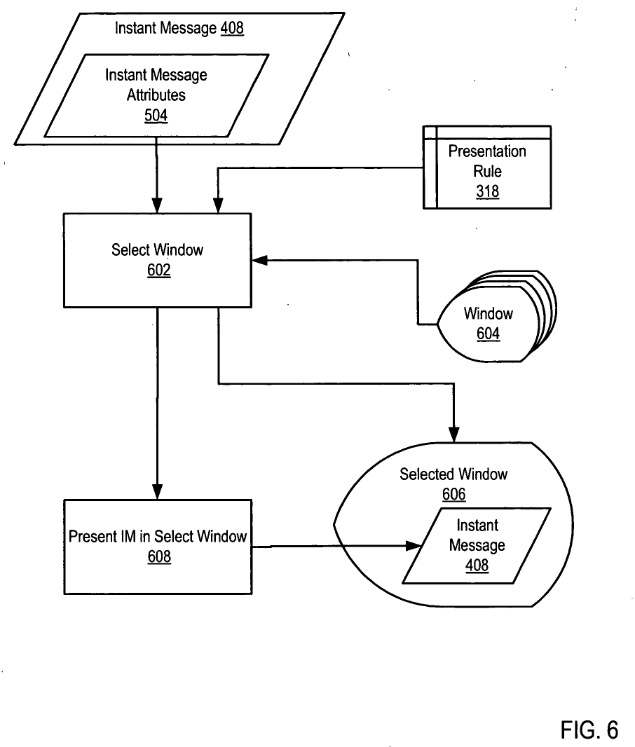

The method of FIG. 4 also includes presenting (412) to the recipient the instant message (408) if the instant message (408) meets (418) the threshold priority criteria (310). Presenting (412) to the recipient the instant message (408) according the method of FIG. 4 may be carried out by selecting one of a plurality of prioritized windows to present the instant message and presenting the instant message in the selected window as discussed below with reference to FIG. 6. Presenting the instant message in a selected prioritized window allows the highest priority instant messages to be presented, for example, in the top window and the lowest priority instant messages to be presented in the bottom window.

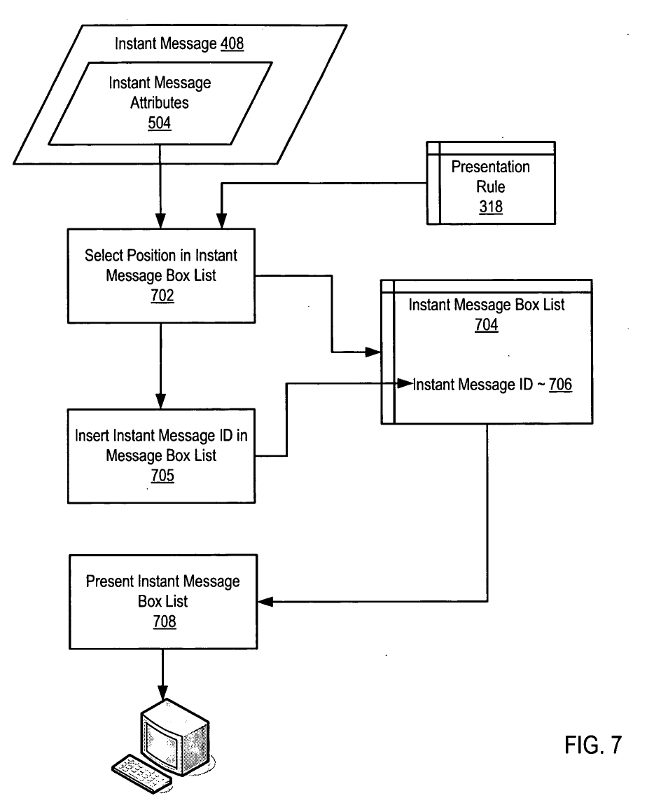

Presenting (412) to the recipient the instant message (408) according the method of FIG. 4 may also be carried out by selecting a position in an instant message box list for an identification of the instant message, inserting an identification of the instant message in the instant message box list, and presenting the instant message box list to the recipient as described below with reference to FIG. 7. Presenting the instant message in a position in a message box list allows for a convenient way of presenting the recipient with instant messages that are of sufficient priority.

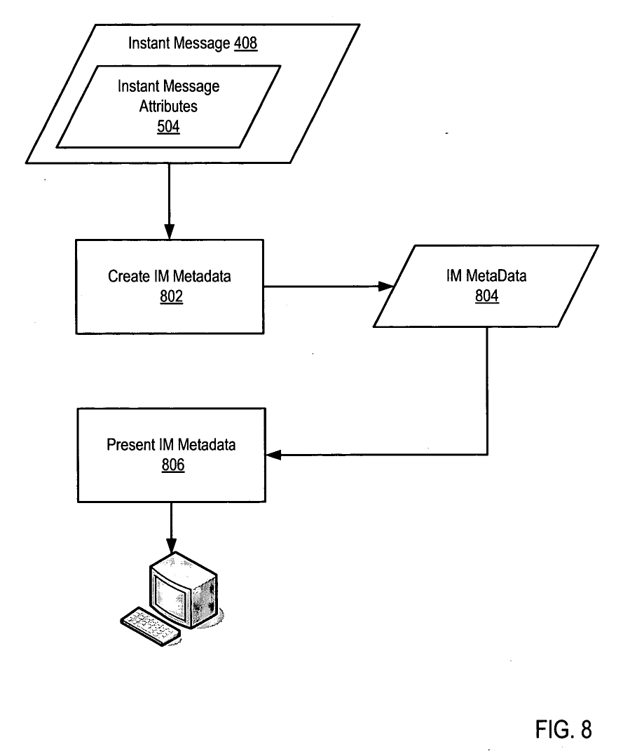

Presenting (412) to the recipient the instant message (408) according the method of FIG. 4 may also be carried out creating instant message metadata describing the instant message and presenting to the recipient the instant message metadata as described below with reference to FIG. 8. Presenting the user with instant message metadata provides a vehicle to present the recipient with information about instant messages that have been received and that meet the threshold of priority criteria.

The method of FIG. 4 also includes forwarding (414), in an email message (416), the content of the instant message (408) if the instant message (408) does not (420) meet the threshold priority criteria (310). Forwarding, in an email message, the content of the instant message if the instant message does not meet the threshold priority criteria may be carried out by copying the content of the instant message, inserting the content of the instant message in an email message, and sending the email message to the recipient.

For further explanation, FIG. 5 sets forth a flow chart illustrating an exemplary method for determining whether the instant message meets the threshold priority criteria. The method of FIG. 5 includes identifying (502) attributes (504) of the instant message (408). Attributes (504) of the instant message include indicators of factors or conditions surrounding the instant message, or contents of the instant message. Examples of attributes include users listed as sender or recipients of the instant message, the time of receipt of the instant message, one or more keywords included in the instant message, the subject matter of the instant message, and any other indicators of factors or conditions surrounding the instant message, or contents of the instant message that will occur to those of skill in the art.

The method of FIG. 5 also includes determining (506) whether the attributes (504) of the instant message (506) meet the threshold priority criteria (310) in dependence upon criteria evaluation rules (322). Determining (506) whether the attributes (504) of the instant message (506) meet the threshold priority criteria (310) in dependence upon criteria evaluation rules (322) may be carried out by comparing the identified attributes of the instant message with the threshold priority criteria established by the recipient and applying a criteria evaluation rule to determine whether the instant message meets the threshold criteria. For further explanation, consider the following exemplary instant message received by a recipient Joe, exemplary threshold priority criteria established by Joe, and an exemplary application of criteria evaluation rules.

IM Message:
From: John Sent: Fri 5/20/2005 2:28 PM
To: Joe
Subject: Important Meeting
Joe,
   We have a big client meeting tomorrow morning at 9:00. Don't forget.
--J

Joe's Threshold Priority Criteria:
Priority Senders List: Adam, James, John, Bob, Harold, Ann, Susan . . .
Priority Keywords: meeting, important, travel, IBM, client, product, release . . .
Priority Receipt Time: 9:00 a.m.-5:00 p.m.

Criteria Evaluation Rule:
If number of IM attributes that match Priority Keywords>2; AND
IM sender included in Priority Senders List; AND
IM sent during priority receipt time; THEN
   IM meets threshold priority

In the example above, the threshold priority criteria include a priority senders list, priority keywords, and a priority receipt time. In the example above, the sender of the instant message, John is on the priority senders list of the established threshold priority criteria. The instant message is sent during the priority receipt time established in the threshold priority criteria. There are thee keywords in the instant message that match priority keywords of the threshold priority criteria; ‘important’, ‘meeting’, and ‘client.’ Applying the criteria evaluation rules to identified attributes of the received instant message and the threshold priority criteria determines that the instant message meets the threshold priority criteria because more than two keywords contained the priority keyword list established in the threshold priority criteria match attributes of the instant message, the sender of the instant message is included in the priority senders list established in the threshold priority criteria, and the instant message is sent during the priority receipt time established in the threshold priority criteria.

For further explanation, FIG. 6 sets forth a flow chart illustrating an exemplary method for presenting to the recipient the instant message if the instant message meets the threshold priority criteria. The method of FIG. 6 includes selecting (602) one of a plurality of prioritized windows (604) to present the instant message in dependence upon attributes (504) of the instant message and at least one presentation rule (318). As discussed above, presentation rules govern the presentation of instant messages that are determined to be of sufficient priority to be presented to the recipient. Selecting (602) one of a plurality of prioritized windows (604) therefore may be carried out by applying a presentation rule to the attributes of the instant message to select one of a plurality of prioritized windows for presenting the instant message. For further explanation consider the following presentation rule and instant message.

IM Message:
From: John Sent: Fri 5/20/2005 2:28 PM
To: Joe
Subject: Important Meeting
Joe,
   We have a big client meeting tomorrow morning at 9:00. Don't forget.
--J

Presentation Rule:
If sender is John; THEN
   select top window; AND
   Present instant message in top window.

Selecting one of a plurality of prioritized windows in the example above is carried out by applying a presentation rule dictating that if the instant message is sent from John then the instant message is presented in the top window. In the example above, the instant message is sent from John, and therefore the instant message is presented in the top window.

The method of FIG. 6 also includes presenting (608) the instant message (408) in the selected window (606). Presenting (608) the instant message (408) in the selected window (606) is typically carried out by displaying the content of the instant message in the selected window. Presenting the instant message in a selected prioritized window allows the highest priority instant messages to be presented, for example, in the top window and the lowest priority instant messages to be presented in the bottom window.

For further explanation, FIG. 7 sets forth a flow chart illustrating an exemplary method for presenting to the recipient the instant message if the instant message meets the threshold priority criteria. The method of FIG. 7 includes selecting (702) a position in an instant message box list (704) for an identification (706) of the instant message in dependence upon attributes (504) of the instant message and at least one presentation rule (318). As discussed above, presentation rules govern the presentation of instant messages that are determined to be of sufficient priority to be presented to the recipient. Selecting (702) a position in an instant message box list (704) for an identification (706) of the instant message therefore may be carried out by applying a presentation rule to the attributes of the instant message to select a position in an instant message box list (704) for an identification of the instant message. For further explanation consider the following presentation rule and instant message.

IM Message:
From: John Sent: Fri 5/20/2005 2:28 PM
To: Joe
Subject: Important Meeting
Joe,
   We have a big client meeting tomorrow morning at 9:00. Don't forget.
--J

Presentation Rule:
If sender is John; THEN
   select top position; AND
   assign ID to the message; and
   insert message ID in top position.

Selecting a position in an instant message box list for an identification of the instant message therefore may be carried out by applying the exemplary presentation rule dictating that if the instant message is sent from John then the instant message is presented in the top position on the list. In the example above, the instant message is sent from John, and therefore the instant message is presented in the position of the list.

The method of FIG. 7 also includes inserting (705) an identification (706) of the instant message in the instant message box list (704). An identification of the instant message may be implemented as any identification of the instant message. Such identifications may be unique numbers or combinations of senders' names and numbers, subjects, unique names or any other identification of the instant message that will occur to those of skill in the art.

The method of FIG. 7 also includes presenting (708) the instant message box list (704) to the recipient. Presenting (708) the instant message box list (704) to the recipient may be carried out by displaying the instant message box list in a window designated for the display of instant message identifications and instant message metadata. Presenting the instant message in a position in a message box list allows for a convenient way of presenting the recipient with instant messages that are of sufficient priority.

For further explanation, FIG. 8 sets forth a flow chart illustrating an exemplary method for presenting to the recipient the instant message if the instant message meets the threshold priority criteria. The method of FIG. 8 includes creating (802) instant message metadata (804) describing the instant message (408). Instant message metadata (804) describing the instant message (408) is information about the instant message. Such metadata may be one or more of the attributes of the instant message itself such as identifications of the sender, the time of receipt, keywords contained in the instant message, or any other attributes that will occur to those of skill in the art. Such metadata may also be information not contained in or as an attribute of the instant message, such as for example, the determined priority of the instant message, the size of the instant message, the number of words in the instant message, or any other information describing the instant message that will occur to those of skill in the art.

The method of FIG. 8 also includes presenting (806) to the recipient the instant message metadata (804). Presenting (806) to the recipient the instant message metadata (804) may be carried out by displaying the instant message box list in a window designated for the display of instant information. Instant message metadata may be usefully displayed in conjunction with identifications of instant messages such as in a message box list. Presenting (806) to the recipient the instant message metadata (804) advantageously provides a recipient with additional information useful in selecting an instant message to read.

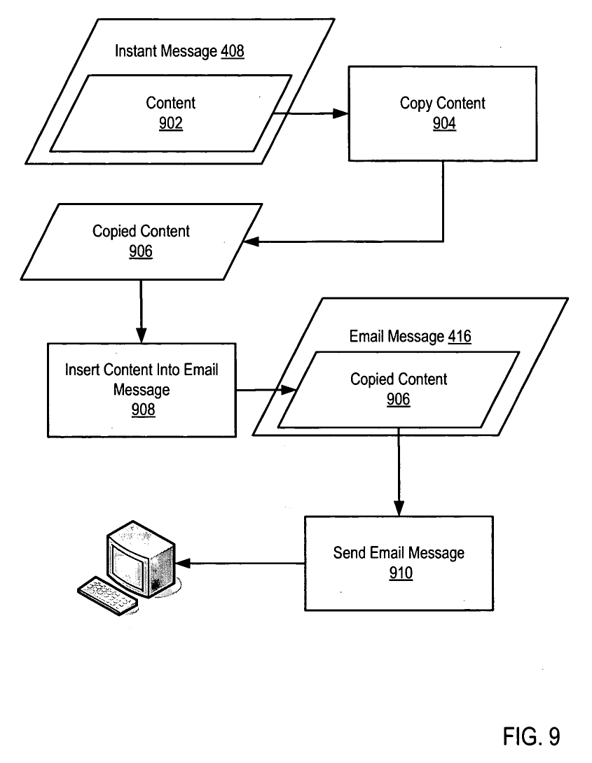

For further explanation, FIG. 9 sets forth a flow chart illustrating an exemplary method for forwarding, in an email message, the content of the instant message if the instant message does not meet the threshold priority criteria. The method of FIG. 9 includes copying (904) the content (902) of the instant message (408); inserting (908) the copied content (906) of the instant message (408) in an email message (416); sending (910) the email message (416) to the recipient. A recipient may advantageously review as email messages the content of instant messages that were not of sufficient priority to be presented to the recipient as an instant message. The method of FIG. 9 advantageously provides a vehicle for forwarding the content of low priority instant messages to a recipient in a manner than allows the recipient to review such forwarded content at the recipient's leisure.

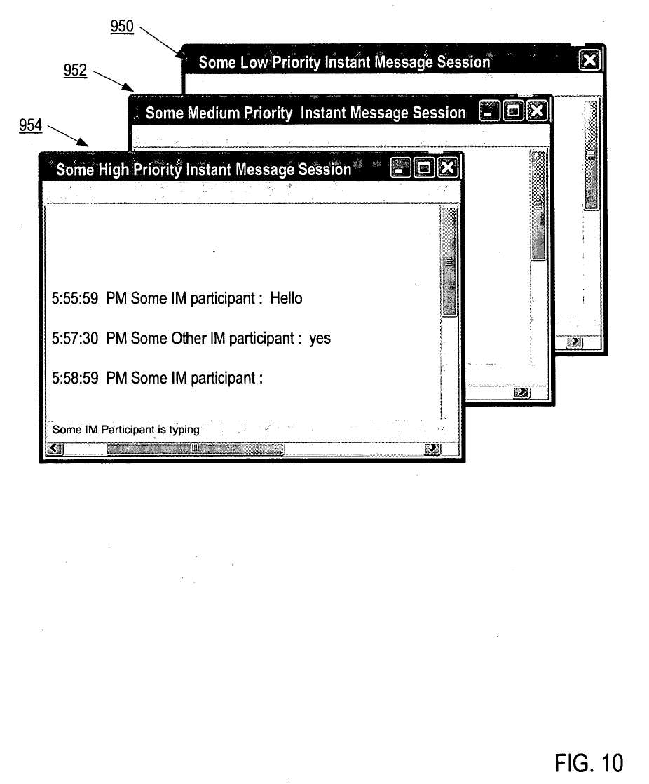

For further explanation, FIG. 10 sets forth a block diagram of three prioritized windows each of which contain an instant message presented to a recipient in accordance with the present invention. The example of FIG. 10 includes a high priority instant message presented within a displayed instant message session in the top or high priority window (954). The example of FIG. 10 includes a medium priority instant message presented within a displayed instant message session in the medium priority window (952). The example of FIG. 10 also includes a low priority instant message presented within a displayed instant message session in the medium priority window (950). Each of the instant messages presented in the example of FIG. 10 regardless of priority are of sufficient priority to meet the threshold priority criteria established by the recipient and are therefore presented in one of the prioritized windows (950, 952, 954) of FIG. 10. Presenting the instant message in a selected prioritized window provides a convenient way of displaying the highest priority instant messages to a recipient.

The exemplary prioritized windows of FIG. 10 are included for explanation and not for limitation. In fact, prioritized windows useful in presenting instant messages to recipients in accordance with the present invention may in implemented in many forms and all such forms are well within the scope of the present invention.

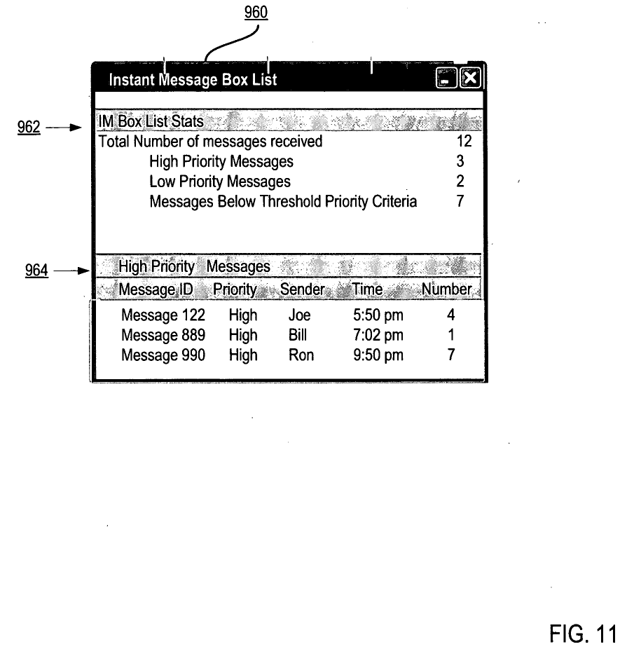

For further explanation, FIG. 11 sets forth a block diagram illustrating an exemplary instant message box list (960) in accordance with the present invention. The exemplary instant message box list (960) of FIG. 11 includes instant message box list statistics (962) describing the messages in the instant message box list and messages not contained in the box list, but instead sent as email, because the messages are below the threshold priority criteria. The instant message box list statistics (962) identifies that twelve instant messages have been received and that three are high priority messages and two are low priority messages. The instant message box list statistics (962) identifies that seven instant messages have been received that are below the threshold priority criteria and such messages are typically forwarded to the recipient as email.

The exemplary instant message box list (960) of FIG. 11 includes a display (964) of a list of identifications and metadata of the high priority messages. The exemplary instant message box list (960) of FIG. 11 identifies the high priority messages by a message ID and displays the determined priority of the message, the sender of the message, the time or recipient of the message, and the number of messages that have been received in the instant message session associated with the high priority instant message.

The exemplary instant message box list (960) of FIG. 11 is included for explanation and not for limitation. In fact, instant message box list (960) useful in presenting instant messages to recipients according to the present invention may be implemented in many different forms and all such forms are well within the scope of the present invention.

Exemplary embodiments of the present invention are described largely in the context of a fully functional computer system for controlling presentation of instant messages to a recipient. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for controlling presentation of instant messages to a recipient in a data processing system, the method comprising:
establishing threshold priority criteria;
receiving an instant message;
determining whether the instant message meets the threshold priority criteria; and
presenting to the recipient the instant message if the instant message meets the threshold priority criteria.

2. The method of claim 1 wherein determining whether the instant message meets the threshold priority criteria further comprises:
identifying attributes of the instant message; and
determining whether the attributes of the instant message meet the threshold priority criteria in dependence upon criteria evaluation rules.

3. The method of claim 1 wherein presenting to the recipient the instant message if the instant message meets the threshold priority criteria further comprises:
selecting one of a plurality of prioritized windows to present the instant message in dependence upon attributes of the instant message and at least one presentation rule; and
presenting the instant message in the selected window.

4. The method of claim 1 wherein presenting to the recipient the instant message if the instant message meets the threshold priority criteria further comprises:
selecting a position in an instant message box list for an identification of the instant message in dependence upon attributes of the instant message and at least one presentation rule;
inserting an identification of the instant message in the instant message box list; and
presenting the instant message box list to the recipient.

5. The method of claim 1 wherein presenting to the recipient the instant message if the instant message meets the threshold priority criteria further comprises:
creating instant message metadata describing the instant message; and
presenting to the recipient the instant message metadata.

6. The method of claim 1 further comprising forwarding, in an email message, the content of the instant message if the instant message does not meet the threshold priority criteria.

7. The method of claim 6 wherein forwarding, in an email message, the content of the instant message if the instant message does not meet the threshold priority criteria further comprises:
copying the content of the instant message;
inserting at least a portion of the content of the instant message in an email message; and
sending the email message to the recipient.

8. A system for controlling presentation of instant messages to a recipient, the system comprising:
a computer processor;
a computer memory operatively coupled to the computer processor, the computer memory having disposed within it computer program instructions capable of:
establishing threshold priority criteria;
receiving an instant message;
determining whether the instant message meets the threshold priority criteria; and
presenting to the recipient the instant message if the instant message meets the threshold priority criteria.

9. The system of claim 8 wherein the computer memory also has disposed within it computer program instructions capable of:
identifying attributes of the instant message; and
determining whether the attributes of the instant message meet the threshold priority criteria in dependence upon criteria evaluation rules.

10. The system of claim 8 wherein the computer memory also has disposed within it computer program instructions capable of:
selecting one of a plurality of prioritized windows to present the instant message in dependence upon attributes of the instant message and at least one presentation rule; and
presenting the instant message in the selected window.

11. The system of claim 8 wherein the computer memory also has disposed within it computer program instructions capable of:
selecting a position in an instant message box list for an identification of the instant message in dependence upon attributes of the instant message and at least one presentation rule;
inserting an identification of the instant message in the instant message box list; and
presenting the instant message box list to the recipient.

12. The system of claim 8 wherein the computer memory also has disposed within it computer program instructions capable of:
creating instant message metadata describing the instant message; and
presenting to the recipient the instant message metadata.

13. The system of claim 8 wherein the computer memory also has disposed within it computer program instructions capable of forwarding, in an email message, the content of the instant message if the instant message does not meet the threshold priority criteria.

14. The system of claim 13 wherein the computer memory also has disposed within it computer program instructions capable of:
copying the content of the instant message;
inserting at least a portion of the content of the instant message in an email message; and
sending the email message to the recipient.

15. A computer program product for controlling presentation of instant messages to a recipient, the computer program product disposed upon a signal bearing medium, the computer program product comprising:
computer program instructions for establishing threshold priority criteria;
computer program instructions for receiving an instant message;
computer program instructions for determining whether the instant message meets the threshold priority criteria; and
computer program instructions for presenting to the recipient the instant message if the instant message meets the threshold priority criteria.

16. The computer program product of claim 15 wherein computer program instructions for determining whether the instant message meets the threshold priority criteria further comprise:
computer program instructions for identifying attributes of the instant message; and
computer program instructions for determining whether the attributes of the instant message meet the threshold priority criteria in dependence upon criteria evaluation rules.

17. The computer program product of claim 15 wherein computer program instructions for presenting to the recipient the instant message if the instant message meets the threshold priority criteria further comprise:
computer program instructions for selecting one of a plurality of prioritized windows to present the instant message in dependence upon attributes of the instant message and at least one presentation rule; and
computer program instructions for presenting the instant message in the selected window.

18. The computer program product of claim 15 wherein computer program instructions for presenting to the recipient the instant message if the instant message meets the threshold priority criteria further comprise:
computer program instructions for selecting a position in an instant message box list for an identification of the instant message in dependence upon attributes of the instant message and at least one presentation rule;
computer program instructions for inserting an identification of the instant message in the instant message box list; and
computer program instructions for presenting the instant message box list to the recipient.

19. The computer program product of claim 15 wherein computer program instructions for presenting to the recipient the instant message if the instant message meets the threshold priority criteria further comprise:
computer program instructions for creating instant message metadata describing the instant message; and
computer program instructions for presenting to the recipient the instant message metadata.

20. The computer program product of claim 15 further comprising computer program instructions for forwarding, in an email message, the content of the instant message if the instant message does not meet the threshold priority criteria.
